(19) United States
(12) Patent Application Publication
(10) Pub. No.: US 2003/0011173 A1
(43) Pub. Date: Jan. 16, 2003

(54) Folding fishing cart

(76) Inventor: Harold D. Shall, Largo, FL (US)

Correspondence Address: HAROLD D. SHALL, 1101 BELCHER RD. SOUTH; SUITE B, LARGO, FL, 33771, US

(21) Appl. No.: 09/905,374

(22) Filed: Jul. 16, 2001

(51) Int. Cl. B62B 3/00

(52) U.S. Cl. 280/651; 280/639

(57) ABSTRACT

A folding fishing cart including a collapsible box-like structure mounted on a pair of ground engaging wheels with a handle having telescoping portions being receivable in the rear wall of the box-like structure, and a plurality of fishing pole carrying tubular members carried by the front wall of the box-like structure with the axis of the tubular members being slanted relative to the front wall so that the tops of the tubular members are farther from the wall than the bottom.

### BACKGROUND OF THE INVENTION

1) Field of the Invention

This invention relates to carriers for fishing equipment generally and more particularly to a folding cart with a storable handle, which cart has formed therewith a structure for carrying fishing rods.

2) Description of Prior Art

Prior art devices for carrying fishing equipment and fishing poles are well known, such as seen in Pat. No. Des.378,456. However such devices are not collapsible, nor is its handle storable so as to provide a compact structure when not in use for easy transportation in the trunk of a vehicle. A device as seen in U.S. Pat. No. Des 264,888, while being collapsible, does not have storable handles nor does it provide a suitable imperforate container when unfolded so as to contain and convey small loose parts. Devices like that seen in U.S. Pat. No. 5,159,777, are collapsible, but do not have storable handles, and the storage container portion, while being imperforate, is not collapsible.

### SUMMARY OF THE INVENTION

It is therefore an object of this invention to provide a folding fishing cart with a storable handle and a storage container portion which can be unfolded to provide an imperforate container having an open top, which container portion can be folded to a collapsed condition, and wherein a portion of the container forms the structure in which the handle can be stored and which structure has mounted thereon ground engaging wheels.

### BRIEF DESCRIPTION OF THE DRAWINGS

FIG. 1 is a front perspective view of a folding fishing cart of this invention in its unfolded operative position;

FIG. 2 is a side elevational view of the fishing cart of FIG. 1 with the handle in its stored position and with the bottom wall of the container partially folded up;

FIG. 3 is a plan view of the device of FIG. 1 showing the clamps for holding the container in its folded condition;

FIG. 4 is a view like FIG. 3 with the container partially folded; and

FIG. 5 is a view like FIG. 4 with the container completely folded and the clamps in place.

### DETAILED DESCRIPTION OF THE PREFERRED EMBODIMENT

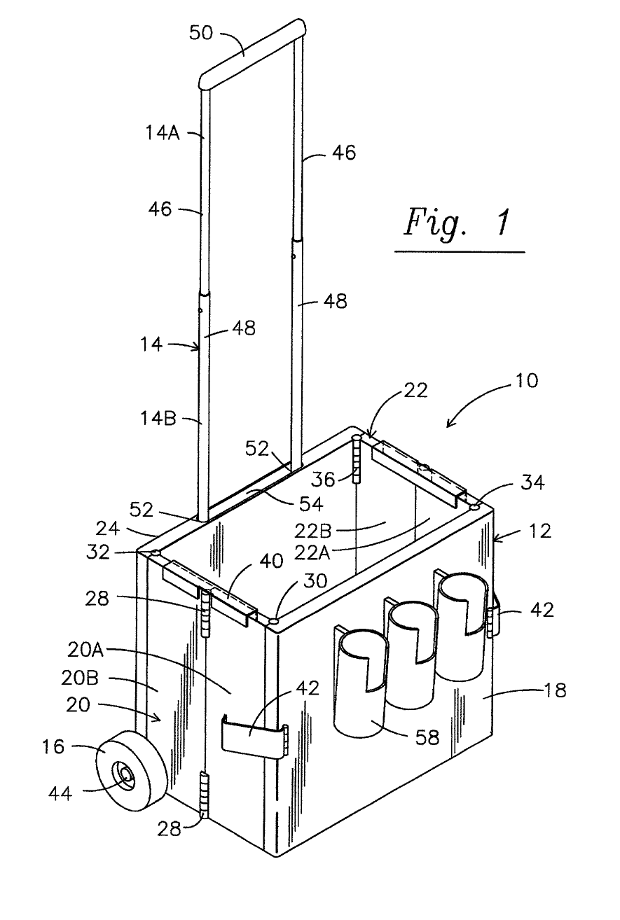

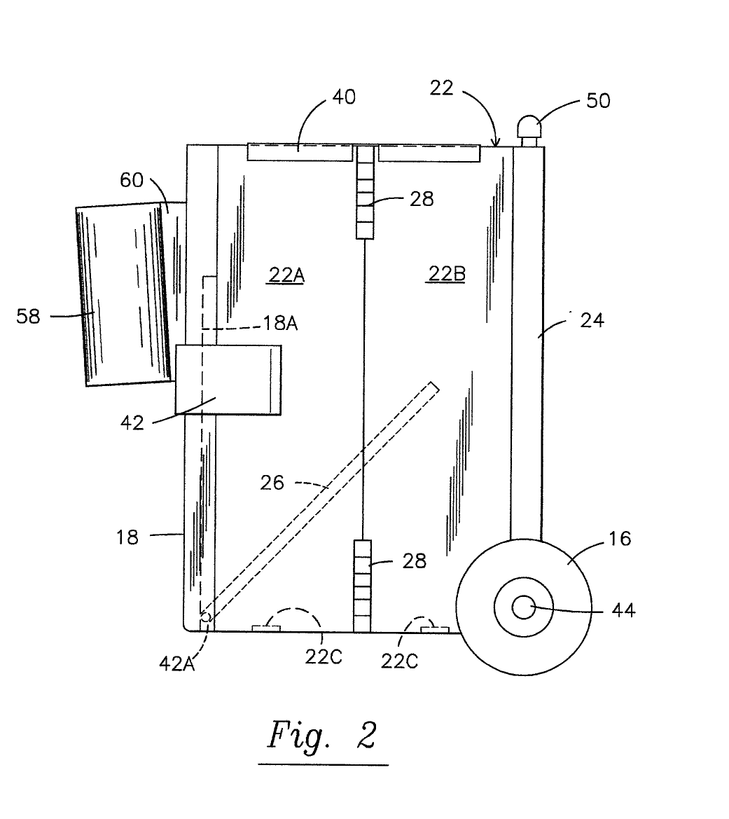

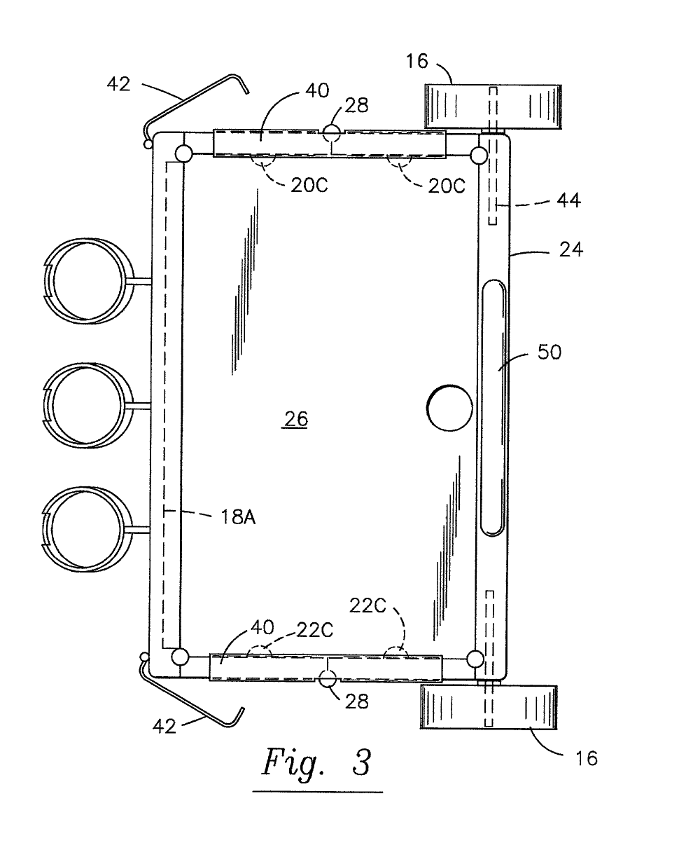

Referring now to the drawings, a folding fishing cart is shown generally at 10, and includes a container portion 12, a handle portion 14, and a pair of laterally spaced ground engaging wheels 16. The container portion 12 includes a front wall 18, a left and a right foldable side wall 20 and 22, respectively, a rear wall 24 and a bottom wall shown at 26 in FIGS. 2 and 3. The side walls 20 and 22 are divided vertically into fore and aft portions 20A and 20B and 22A and 22B, respectively, with a pair of vertically spaced hinges 28 hingedly securing the fore and aft sections so that the sections can pivot inwardly relative to the front wall 18 and the rear wall 24. This pivoting movement is enabled by a pair of vertically spaced hinges 30(only the top hinge 30 being shown) pivotly connecting the portion 20A to the front wall 18, and a pair of vertically spaced hinges 32 (only the top hinge 32 being shown) pivotly connecting the portion 20B to the rear wall 24. Likewise, the portion 22A is pivotly connected to the front wall 18 by a pair of vertically spaced hinges 34 (only the top hinge 34 being shown), and the portion 22B is pivotly connected to the rear wall 24 by a pair of vertically spaced hinges 36 (only the top hinge 36 being shown. When the container is in its open position shown in FIG. 1, a first elongated channel member 40, of generally “U” shaped cross section, is placed on top of the portions 20A and 20B, thereby holding them in their open-aligned position, and a second channel member 40 is placed on top of the portions 22A and 22B, thereby holding them in their open-aligned position.

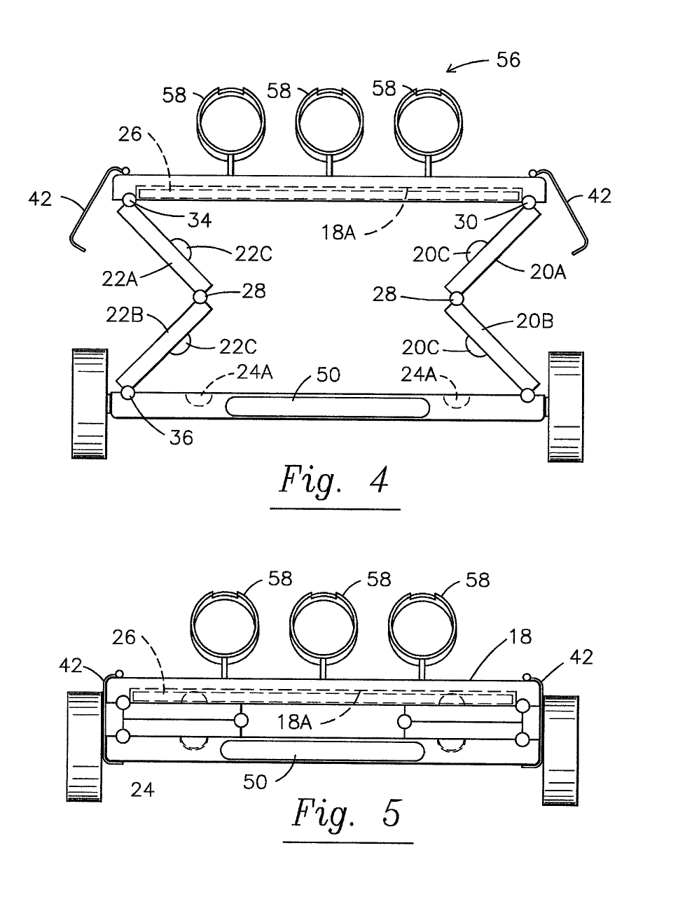

As seen in FIG. 2, the bottom wall 26 is hingedly connected at its lower or forward end to the front wall 18 by a laterally extending pivot pin 42A, whereby the wall 26 can be pivoted from its horizontal-open position, as seen in FIG. 3, wherein the bottom thereof is supported at its lateral edges on support shoulders 20C formed medially on the inside lower edge of the wall portions 20A and 20B and on support shoulders 22C formed medially on the inside lower edge of the wall portions 22A and 22B, to its folded position as seen in FIGS. 4 and 5; FIG. 2 showing wall 26 in its intermediate position. The front wall 18 is countersunk as shown at 18A in FIGS. 4 and 5, so that the bottom wall 26 and the support shoulders 20C and 22C can be received within the countersunk area 18A when the container 12 is folded flat as seen in FIG. 5, and the rear wall 24 is countersunk as shown at 24A to receive the support shoulders 20C and 22C on wall portions 20B and 22B. A pair of “U” shaped clamp members 42 are pivotally secured to the laterally opposed sides of the front wall 18, and extend over and overlie the rear wall 24 when the container 12 is folded closed, as seen in FIG. 5, to thereby secure the closed position of the container 12.

The pair of ground engaging wheels 16 are mounted for rotation on the laterally opposed ends of an axle shaft 44; the latter being mounted in the rear wall 24 near the bottom thereof. The handle 14 is of two piece construction, with an outer portion 14A and an inner portion 14B, and with the side rods 46 of the outer portion 14A being telescopically received in the tubular rods 48 of the inner portion 14B. A hand grip portion 50 connects the top of the rods 46 of the upper portion 14A of the handle 14. The lower end of each of the tubular rods 48 is telescopically received in one of a pair of laterally spaced vertically extending openings 52 located within a depression 54 formed in the top of the rear wall 24, which depression is sized and shaped to receive most of the hand grip portion 50 when the latter, along with the remainder of the handle 14, are in their fold position.

Holders for the handles of fishing rods shown generally at 56 are provided to carry fishing rods on the carrier 12. The holders may be formed unitarily with the front wall 18 of the container 12, or may be formed separately and then securely attached to the front wall in a suitable manner, as by adhesives, screws, bolts, and the like. The holders 56 have a plurality of tubular portions, shown at 58 and a base portion 60 formed integrally with each of the tubular portions, and with the base portions secured to or formed integrally with the front wall 18. The base portion 60, as clearly seen in FIG. 2, is wider at the top than it is at the bottom, so that the tubular portion 58 is slanted outwardly with the top of the base portion extending farther from the tubular portion than the bottom thereof. Thus the vertical axis of the tubular member slants outwardly with respect to the vertical and the wall 24, and when a user of this device pulls the same along behind themself, the upper ends of any fishing rods carried by the device 10 will have a lesser tendency of hitting the user in the back of his or her head. With the handle 14 in its lower position, as seen in FIGS. 2-5, and the fishing cart 10 in its folded and clamped position shown in FIG. 5, the cart can easily be place in the trunk of a vehicle or into some other confined space, while, when unfolded into its open position, as seen in FIG. 1, it is operative to carry fishing rods and supplies with ease.

While only a single embodiment of this invention has been shown and described, it is apparent that many changes can be made therein without departing from the scope of this invention as define by the following claims.

What is claimed is:

1) A folding fishing cart comprising in combination, a collapsible box-like structure having an open and a collapsed condition and having a front wall, a pair of laterally spaced side walls hingedly connected to said front wall, a rear wall hingedly connected to said side walls, and a bottom wall having a lower position wherein it encloses the bottom of said box-like structure and an upper position lying against one of said other walls and being hingedly connected to said one of the other of said walls, at least another of said other walls including support means for supporting the adjacent portion of said bottom wall when in its lower position, ground engaging wheel means carried by said rear wall, a handle member attached to said rear wall for moving said box-like structure on said wheels, said handle member having a first part telescopically received in said rear wall and a graspable handle bearing second part telescopically received in said first part, and fishing pole carrying means fixedly carried by said front wall on the forward side thereof for carrying at least one fishing pole in a substantially vertically upright position.

2) A folding fishing cart according to claim 1 wherein said fishing pool carrying means includes at least a pair or laterally spaced tubular members each having on elongated substantially vertical central axis, support means connecting said tubular members to said front wall, and wherein said support means is thicker at the top than at the bottom, whereby said tubular members slant forward at the top thereof relative to said front wall.

3) A folding fishing cart according to claim 1 wherein each of said side walls includes a front and a rear portion hingedly connected to each other, and a separate holding member holds said front and rear portion of each of said side walls in alignment when said holding member is in engagement therewith and said box-like member is in its open position.

4) A folding fishing cart according to claim 2 wherein each of said sidewalls includes a front and a rear portion hingedly connected to each other, and a separate holding member holds said front and rear portion of each of said side walls in alignment when said holding member is in engagement therewith and said box-like member is in its open position.

5) A folding fishing cart according to claim 4 wherein each of said separate holding members is an elongated member with a channel shaped cross section, and wherein said rear wall has a depression for receiving said graspable handle when said cart is in its folded position.
